(19) United States
(12) Patent Application Publication
(10) Pub. No.: US 2002/0129569 A1
(43) Pub. Date: Sep. 19, 2002

(54) Insta French

(76) Inventor: Steven K. Collins, Pompano Beach, FL (US)

Correspondence Address: STEVE K. COLLINS, 130 SE 9TH STREET, POMPANO BEACH, FL, 33060, US

(21) Appl. No.: 10/072,192

(22) Filed: Feb. 11, 2002

Related U.S. Application Data
(60) Provisional application No. 60/271,219, filed on Feb. 26, 2001.

(51) Int. Cl. E06B 3/964; E04C 2/38

(52) U.S. Cl. 52/204.61; 52/656.8

(57) ABSTRACT

Insta French is a vinyl insert that fits into standard doors and windows. Inserts are installed on the inside or outside of existing sliding glass doors or windows. Insta French Inserts have no outer edge or framings. The door or window edges provide the framing effect. Insta French inserts can be easily removed to clean window glass. They are easily reinstalled to give a glamorous French door look. Anyone can have a French door look without the pain rendering cleaning of small multiple panes of glass. No costly expense of replacing doors and windows. Insta French creates a whole new look in minutes.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Not applicable

### BRIEF SUMMARY OF THE INVENTION

Insta French is a French door inserts that installs on the inside or outside of existing sliding glass doors or windows. The Insta French inserts attach to the inside of the doorframes or windows. No permanent fixtures are used. No tools are needed to install Insta French inserts. Insta French inserts can be easily removed for cleaning of window glass. Easily reinstalled to give a glamorous French door look. Insta French Inserts will come in various sizes and colors. To match existing door and window frames.

Insta French Inserts has no outer edge or framing. The door or window provides the framing effect.

Anyone can have a French door look without the pain rendering cleaning of small multiple panes of glass. No costly expense of replacing doors and windows. Insta French creates a whole new look in minutes.

### BRIEF DESCRIPTION OF THE SEVERAL VIEWS OF THE DRAWINGS

FIG. 1 Insta French Inserts [Page 6]

FIG. 2 Insta French Inserted into door [Page 6]

FIG. 3 Measurements [Page 7]

FIG. 4 Notches and Tabs [Page 8]

FIG. 5 Caps [Page 9]

### DETAILED DESCRIPTION OF THE INVENTION

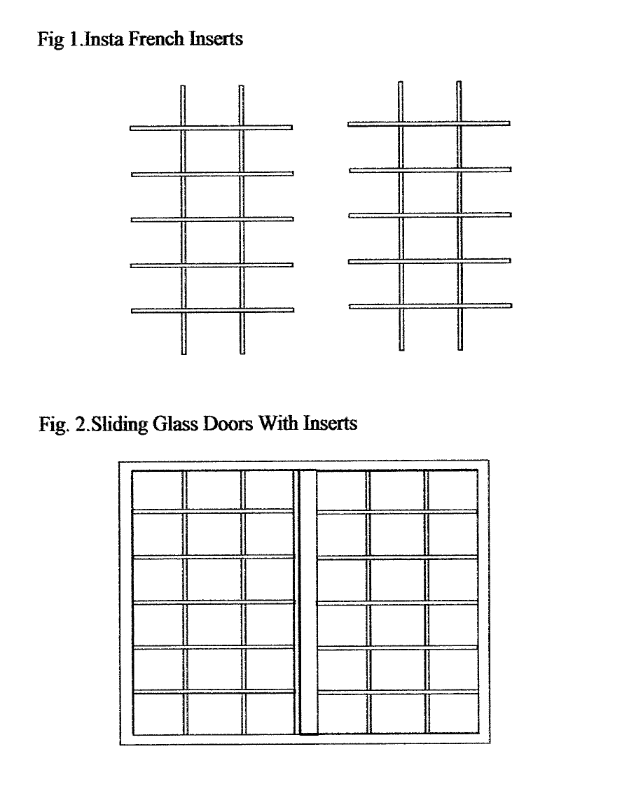

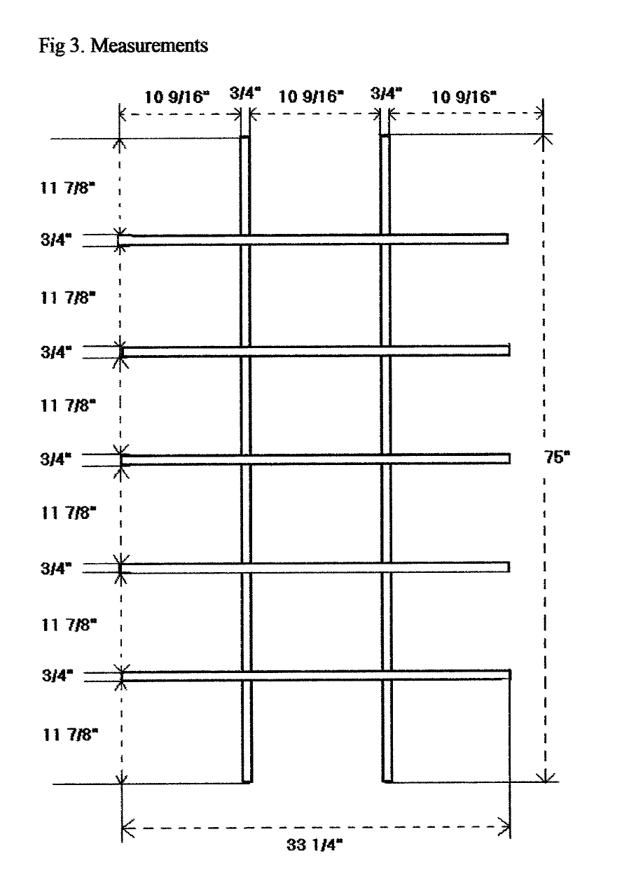

Insta French is a vinyl insert, [FIG. 1] No Tools required for installation. Insta French is made one piece of solid vinyl. Made to fit the dimension of standard doors and windows. [FIG. 2 & 3]

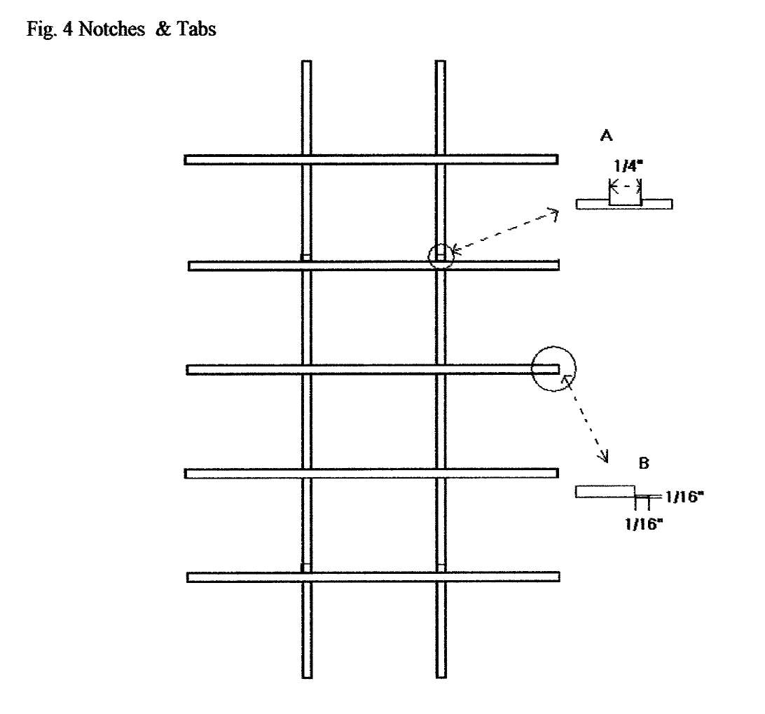

Each insert is ¼ inch thick. Each slat is ¾-inch wide. At the end of each slat is a 1/16-inch thick and 1/16-inch long tab [FIG. 4-B]. The tabs hold the Insta French Insert into door and windows.

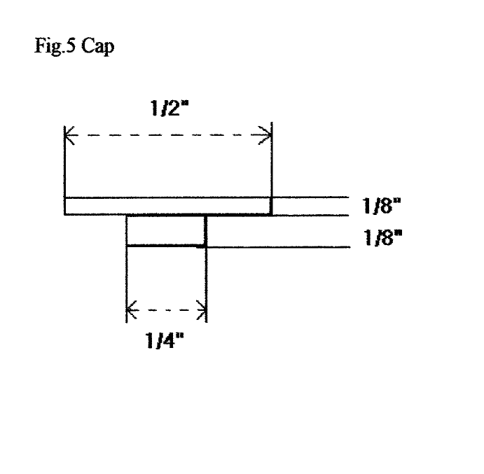

At the 2^{nd} nd horizontal slat from the top, and at the 2^{nd} horizontal slat from the bottom a ¼-inch notch. The ¼-inch vinyl is indented to ⅛ inch thick. The indented ¼-inch notch gives the vinyl insert ability to be flexible for packaging. [FIG. 4-A] Decorative caps are placed over notches during installation. The cap is made of the same vinyl as the insert, ¾-inch wide, ½-inch in length. With tab centered on the bottom, ⅛-inch by ¼-inch thick. Caps cover the notches, [FIG. 5] and lock the Insta French insert into place.

Insta French Insert is molded into one solid piece of vinyl. It can be inserted doors and windows in one easy step. Gives the illusion of stylist French doors. They are easily removed to wash windows and reinstalled in minutes.

Insta French vinyl insert is very strong and weather resistant. Insta French decorated purpose only.

1. What I claim as my invention is Insta French French₁₃ Door Inserts.
